(19) United States
(12) Patent Application Publication
(10) Pub. No.: US 2014/0158297 A1
(43) Pub. Date: Jun. 12, 2014

(54) THERMOPLASTIC STRUCTURES DESIGNED FOR WELDED ASSEMBLY

(71) Applicant: SMARTER PLANET LLC, SAN FRANCISCO, CA (US)

(72) Inventors: Gregory William Pronko, San Francisco, CA (US); Michael Robert O'Reilly, San Francisco, CA (US); David Mayer de Rothschild, Buckinghamshire (GB); Frank P. Becking, Palo Alto, CA (US)

(73) Assignee: SMARTER PLANET LLC, SAN FRANCISCO, CA (US)

(21) Appl. No.: 13/951,249

(22) Filed: Jul. 25, 2013

Related U.S. Application Data
(63) Continuation of application No. PCT/US2012/023014, filed on Jan. 27, 2012.
(60) Provisional application No. 61/437,492, filed on Jan. 28, 2011.

(51) Int. Cl. B29C 65/00; B29C 65/02

(52) U.S. Cl. CPC B29C 66/3022; B29C 65/02
USPC 156/308.2

(57) ABSTRACT

Included herein are constructional techniques involving component parts designed with features to assist in welding assembly as well as finished goods produced thereby. The techniques are useful in connection with thermoplastics, thermoplastic composites and especially advantageous as applied to easily recycled self-reinforced thermoplastic composites.

### CROSS-REFERENCE TO RELATED APPLICATIONS

This application is a continuation of International Application No. PCT/US2012/023014, filed Jan. 27, 2012, which claims priority to U.S. Provisional Application Ser. No. 61/437,492, filed Jan. 28, 2011, both of which are incorporated by reference herein in their entirety for all purposes.

### BACKGROUND

Self-reinforced thermoplastic composites have found utility in a variety of fields. Much of the previous innovation has focused on performance attributes, including the ability to shape, reshape and join the composite pieces. Some attention has been given to the material in terms of its potential for recycling and closed-loop “cradle-to-cradle” product cycles or systems.

The assignee hereof (Smarter Planet, LLC) is in the business of implementing such product solutions as its members successfully demonstrated on the Plastiki project. The Plastiki boat was built using a srPET (self-reinforced polyester) composite frame securing 12,000 two-liter bottles for buoyancy. These elements, together with the boat cabin, furniture, rudder and other structural features we built from srPET. Thus, if ever stripped of its rigging, the Plastiki can be fully recycled. It can be inserted into the PET recycling stream and fully utilized in any number of newly-minted consumer goods.

The building of the Plastiki and its voyage across the Pacific Ocean are well publicized. The vessel embodies a vision of recycled/recyclable product use. Through this vision, the public learned key messages of conservation.

Unexpected, however, was the public's keen interest in the underlying srPET technology upon which the craft was built. Government representatives, academic leaders, corporate chiefs and others voiced immediate interest in high-value structural goods produced for and from this recycled “high-tech” material. That interest represents a need which has not been met by others working in the thermoplastic composites field.

In producing such goods, it is often necessary or desirable to weld together various component parts. In the context of the present inventions, features are contemplated to assist in heat bonding elements together. Various design for assembly features are disclosed for improving and/or enabling the subject constructs.

### SUMMARY

The various embodiments described herein are advantageously constructed with thermoplastic composite material. These possibilities are especially beneficial in an ecological sense when implemented with easily recyclable materials. Accordingly, use of srPET composite material is a focus. In this material, high melt (high tenacity fiber component) and lower melt (matrix material component) portions of the srPET material are chemically compatible such that structures can be ground/chipped-up at the end of their useful life and incorporated directly into the existing PET waste stream that now largely constitutes spent two-liter bottles and other beverage containers. However, it is to be understood that the teachings herein are generally applicable to other thermoplastic composite materials such as produced by Comfil, Inc. and/or others. In any case, several such examples are provided in the table below:

| | Reinforcement | Matrix | Weight % |
|---|---|---|---|
| g/m² | Fibre | Fibre | Reinforcement |
| 750 | Glass | LPET | 57 |
| 750 | Glass | PET | 57 |
| 700 | Glass | PP | 60 |
| | | Black | |
| 1485 | Glass | PP | 60 |
| | | Black | |
| 760 | Glass | PPS | 63 |
| 500 | Carbon | LPET | 54 |
| 390 | Carbon | LPET | 54 |
| 1200 | Carbon | LPET | 54 |
| 710 | HTPET | LPET | 50 |
| 555 | HTPET | LPET | 50 |
| 980 | Aramid | LPET | 48 |

Other suitable materials to form layers of composite material utilized in the present inventions are described in any of U.S. Pat. Nos. 3,765,998; 4,414,266; 4238,266; 4,240,857; 5,401,154; 6,828,016; 6,866,738 and US Publication Nos. 2001/0030017 and 2011/0076441 among others.

As for the inventive variations, they include a number of thermoplastic construction “tools” suitable for producing high-value self-reinforced composite structural goods (recreational and otherwise). These may be paired/utilized in connection with known techniques for handling such material. Examples of such techniques defining the state of the art (e.g., for molding, stamping, heating, cooling, etc.) are included in the referenced patents, each patent incorporated by reference herein in its entirely.

The “tools” covered in the subject disclosure are all directed toward producing precursor assemblies or preform constructions that are heated globally or locally to cause thermoplastic material therein to flow and bond the assembly into a unitary (even seamless) structure. These advances comprise a group of weld-facilitating designs selected from: I) Structures with Weld-Enhancing Contours; II) Weld-Ready Flow Features and Coordinated Structures for Welded Assembly; and III) Multi-Modal Composite Preforms for Welded Constructs. Each one describes an approach to providing complementary-shaped elements for the welding process. Often, these are “related” as in a male-female or convex-concave relationship, twinned structure, jig-sawed, complementary function (e.g., hook and loop, etc.) or as otherwise shown and/or described. The present inventions also include the subject products, kits (for production, distribution, sale or otherwise) in which they are included and methods of manufacture and use. More detailed discussion is presented in connection with the figures below.

### BRIEF DESCRIPTION OF THE FIGURES

The figures provided herein may be diagrammatic and are not necessarily drawn to scale, with some components and features exaggerated for clarity. Each of the figures diagrammatically illustrates aspects of the inventions. Of these:

FIG. 1 is a flowchart illustrating processing approaches;

FIGS. 2A and 2B illustrate component welding/bonding with weld-enhancing contours;

FIG. 3 illustrates molding with such an approach and

FIG. 4 illustrates the resultant product;

FIGS. 5-8 illustrate preparation for component welding/bonding with weld-ready features;

FIG. 9 illustrates a multi-modal composite perform as prepared for welding/bonding;

FIGS. 10A and 10B illustrate alternative performs to be used in the assembly shown in FIG. 9; and

FIGS. 11A-11C illustrate related final (i.e., post-bonding/welding) constructions to that shown in FIG. 9.

Variations of the inventions from the examples pictured are contemplated. Accordingly, depiction of aspects and elements of the inventions in the figures are not intended to limit the scope of the invention. However, the figures themselves and included text incorporates features that may be set forth otherwise in the specification may serve as the basis for claim limitations—as originally presented or as introduced by amendment.

### DETAILED DESCRIPTION

As per above, the present inventions includes constructional techniques as well as finished goods produced thereby. The techniques can be regarded as new “tools” that can be applied broadly across the composites fields, especially within the self-reinforced composite field. As such, various exemplary embodiments are described below. Reference is made to these examples in a non-limiting sense. They are provided to illustrate more broadly applicable aspects of the present inventions. Various changes may be made to the inventions described and equivalents may be substituted without departing from the true spirit and scope of the inventions. In addition, many modifications may be made to adapt a particular situation, material, composition of matter, process, process act(s) or step(s) to the objective(s), spirit or scope of the present inventions. All such modifications are intended to be within the scope of the claims made herein.

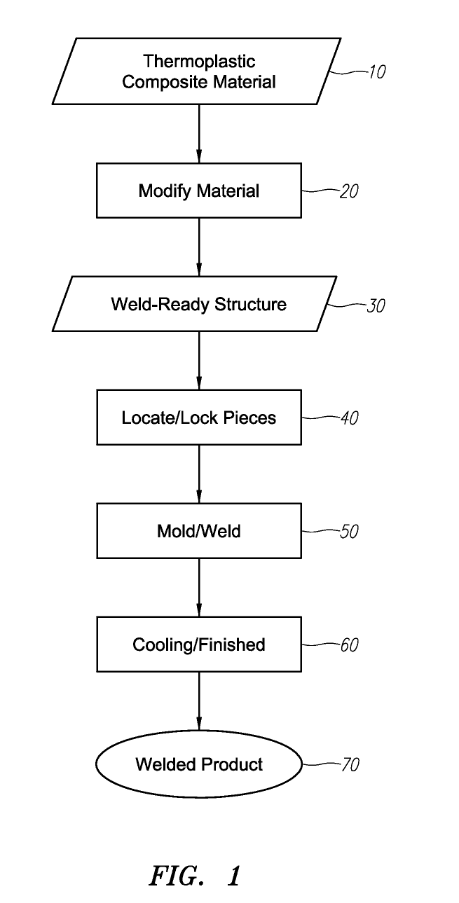

FIG. 1 is a flowchart in which aspects generic to the various approaches are discussed. Specifically, thermoplastic material, preferably thermoplastic composite material, is obtained at 10. This material is modified at 20 in some fashion (i.e., as described below or in a related approach) to produce features to assist in welding one or more weld-ready structures yielded at 30. Then, at 40 the features are used to locate and/or lock the piece(s) so-prepared relative to each other in preparation for bonding/welding. At 50, as part of a overall molding procedure or locally by applying energy and pressure in connection with a heat gun, ultrasonic welder, etc. the parts are bonded at the interface feature(s). Upon any subsequent cooling or finishing at 60 a final welded product is produced at 70.

Structures with Weld-Enhancing Contours

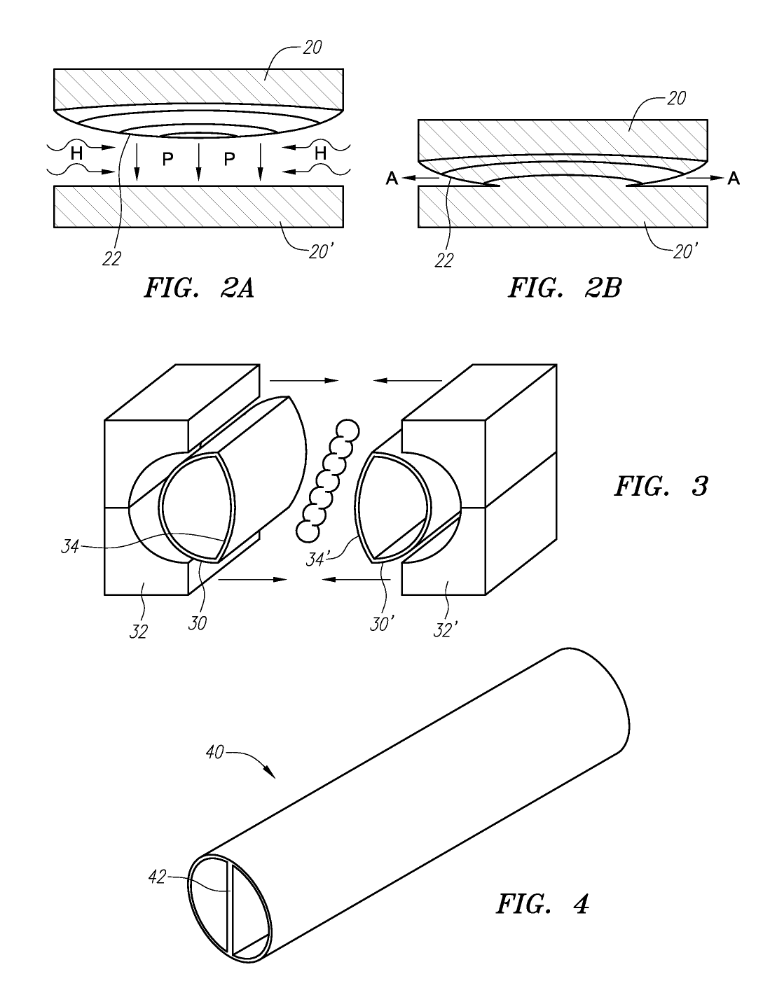

In this aspect, provision is made for welding structures together in a final, flat apposition. As illustrated in FIGS. 1A and 1B, one or more pieces 20, 20′ includes contour(s) 22 included in a piece intended for apposition with another. Convex interface surface(s) are incorporated in one piece or both pieces to provide bonding pressure for contacting pieces. These are deformed to flat (shown in progression in FIG. 2B) during the joining process with the application of heat “H” and pressure “P” illustrated in FIG. 2A. The manner in which air “A” is progressively pressed or “squeegeed” out of the bond area is also illustrated in FIG. 2B. More specifically, as heat and pressure are applied, the middle or initial contact point starts to melt as the bondline area gradually migrates outward. This action helps eliminate inclusion of air bubbles as the complementary-in-function surfaces merge.

Notably, US Patent Application Publication 2005/0082881 shows bonding thermoplastic sheets in which a convex surface is bonded to a flat surface. In contrast, however, the convex surface is maintained, rather than pressed flat (or at least substantially so).

As per FIGS. 2A and 2B, one of the pieces may be flat and the other curved. Or two curved members may be pressed against each other for bonding. FIG. 3 illustrates such action for two halves a ribbed structural beam being assembled. Here, complementary tubing pieces 30, 30′ are brought together (optionally) backed by mold elements 32, 32′ under heat and pressure. The curved sections 34, 34 flatten out against and bond to each other—directly or together with any included film adhesive layer—with little or no air bubble incorporation as the bonding occurs progressively. The curved portions continue to bear on one another until the parts bottom-out against one another along the sides. Such pieces may be backed by mold sections or not. In the pictured example, the bonding and combining of the two tube portions yield a final tubular product 40 as shown in FIG. 4 with a septal wall 42.

Stated otherwise, the heat applied to the area between the convex sides first allows thermoforming of the mating surfaces followed by welding. By achieving a weld bead that travels away from the point where both convex surfaces meet, the elimination of air voids in the finished part is greatly simplified. In doing so, the mold shape may assists in attaining accurate shape and provide a framework to achieve transitional geometry (round to hex) or help assume shapes such as handle grips, textures or locating points for hardware. In one implementation, two halves a ribbed structural beam are provided.

According to this approach, finished tubular product supported with one or more cross members are provided. A similar approach is also achievable using folded or pleated preforms to form a pie shape with multiple supporting members within the cross section of a tubular shape.

The heating applied to facilitate bonding may be inductive in nature (e.g., if the material to be bonded is associated with or doped with ferromagnetic material). In another approach, hot air is blown through the tubular segments (possibly directed by an air curtain). In another approach, hot air blows (as illustrated in FIG. 3) into the gap between the pieces to effect local heating (substantially) only along the intended weld zone. In another approach, radiant energy is applied such as by an elongate halogen lamp or heating element through the bore of each tubular piece 30, 30′.

Of course, the bonding approach is applicable to other structures as well. It may be applied in bonding layered slices, panels and other structures—especially in situations where vacuum (as in a bag or tooling) is not readily applied and trapped air between layers is best avoided. As such, it may be advantageously applied in modular home/barrack/shelter, blast or ballistic curtains/walls, water craft (especially boat) and other construction.

### Weld-Ready Flow Features and Coordinated Structures for Welded Assembly

U.S. Pat. No. 7,235,145 shows raised polymer matrix features associated with a thermoplastic composite body to assist in welding it to another body upon application of energy. A structurally similar approach was employed welding hardware covers on the Plastiki hull. The bumps/elevated features provided reservoirs of matrix material ready to flow and bond the parts when heated. It is heretofore unknown, however, to provide interfacing sets of such features. By providing specifically coordinated features, positional location for welding/bonding can be assisted or ensured.

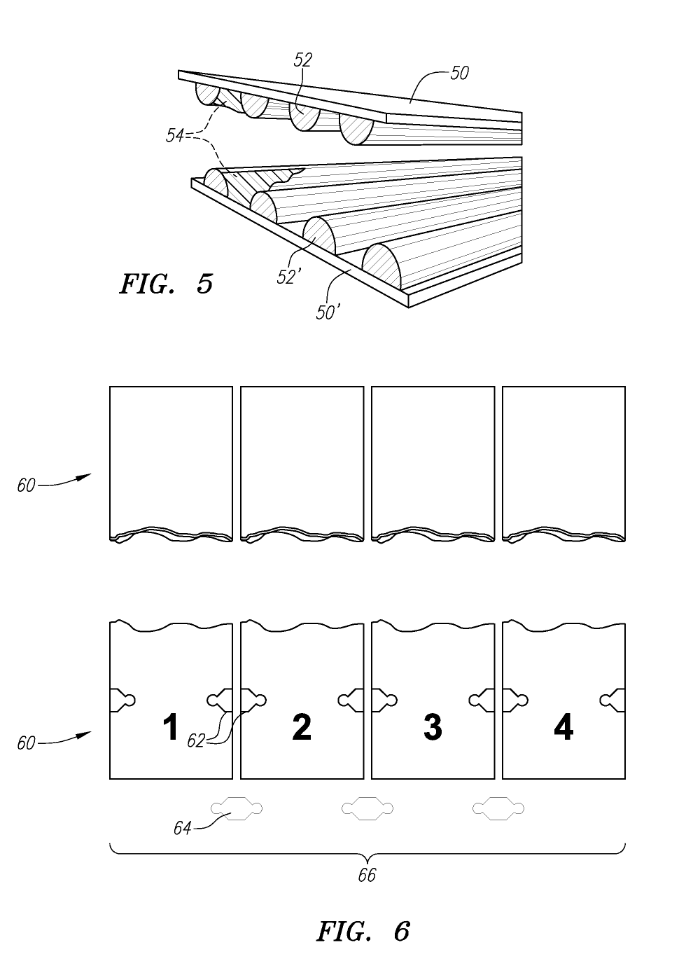

In FIG. 5, backings 50, 50′ (optionally thermoplastic composite material) are covered by a set of interfitting thermoplastic (matrix material) beads or ribs 52, 52′ comprising matrix material. With these, precise positioning can be achieved and then the pieces heated to weld them together. Such positioning enables effortless alignment of the fibers within the composite skins eliminating bends, wrinkles and operator error which would otherwise be detrimental to final product performance.

In addition to the ribs helping mate the composite parts, they provide a “metered” volume of thermoplastic adhesive which is critical to maintain proper fiber/matrix ratios throughout bondline features where the backing comprise thermoplastic composite material. A friction fit or snapping effect may be utilized to hold tapes or panels straight before incorporating heat and pressure from a wide variety of thermoplastic welding/bonding techniques and equipment. Moreover, the complementary bead/rib features may incorporate a core material acting as a bondline thickness/pressure control element. Still further, it is to be appreciated, that the ribs, these may friction fit or snap together—complementary elements may comprise oppositely facing interlocking grids. Indeed the shape of the additional matrix for bonding may be even be shaped like LEGO pieces to mate one sheet with another.

In FIG. 6, another coordinated system is presented. Here a plurality of roof shingles or tiles 60 are shown from above and below. These are advantageously constructed per the techniques described in PCT patent application entitled, “Topo-Slice Thermoplastic Composite Components and Products,” incorporated herein by reference with the additional features of keyways 62 and printed or integrally formed number ordering cutout in the bottom layer defining the shingle. Puzzle-piece keys 64 fit to lock adjacent position of the pieces, with the keys providing a bridge. As such, the position of the shingles can be assembled as desired into a panel 66 in correct order. Once locked, the pieces can be welded together for handling as a unit of 4 or more in the proper repeating sequence to maintain a visually attractive pattern. As an alternative, the shingles may include their own side-to-side puzzle-piece extension and socket members as described in the referenced application and be used for welding. An advantage with the keys is that they are uniform in shape so can be quickly and easily selected and inserted. And if produced with thin stock immediately welded with an ultrasonic head to secure the shingles together.

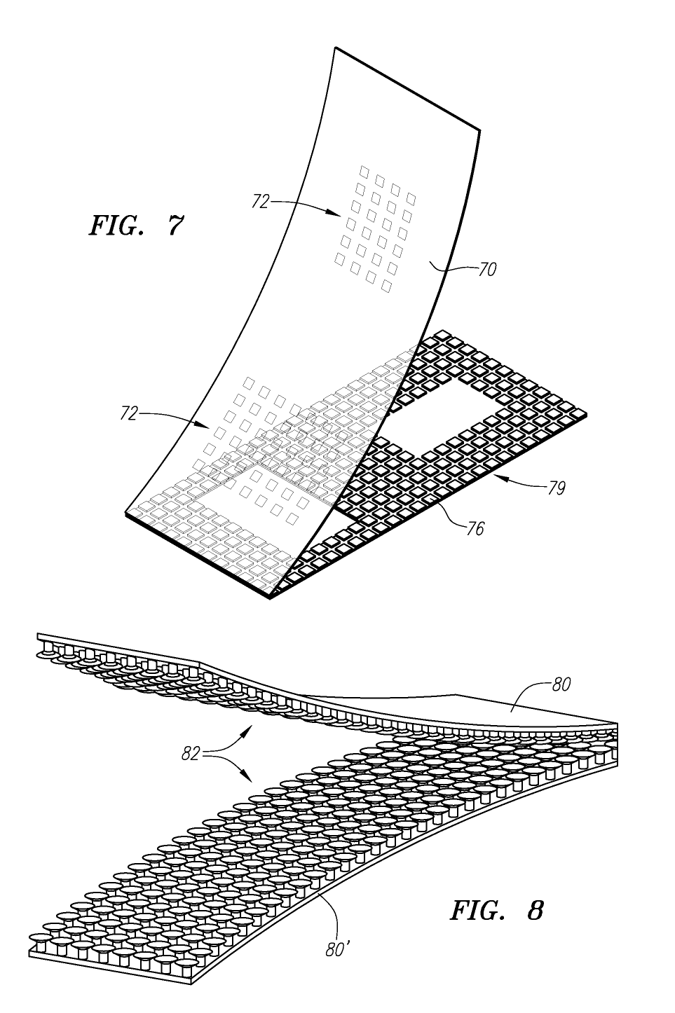

In another variation, the interfacing features can be coordinated to mesh or connect in only in one given overlap/overlay pattern for fail-safe assembly positioning. Such a system is illustrated in FIG. 7. Here a top sheet or backing 70 includes a first matrix-material pattern 72 that can only be interfit with the bottom sheet or backing 74 matrix material pattern 76 in only one orientation. To simplify the complexities of precise fiber alignment required during fiber reinforced thermoplastic composite lamination, the thermoplastic adhesive is optionally printed on pre-oriented fiber-reinforced backing using intuitive geometric alignment methods ensuring that proper alignment has occurred prior to the welding process. As commented upon above, such an approach offers a tremendous aid for assembly. Once assembled, the pieces are advantageously heat-bonded together.

Such features may be designed to provide a vertical mechanical interlock between pieces in preparation and for the further benefit of welding. Regardless if complementary positioning features are provided, another type of unique complementary weld-ready interface is shown in connection with backings 80, 80′ in FIG. 8. Here, thermoplastic matrix adhesive in the form of interlocking patterns are either molded or deposited onto mating surfaces of similar thermoplastic composite materials. Weld features resembling or identical to VELCRO or 3M buttons 82 are provided to attach to one another. They provide a high-strength interlock between the sheets prior to welding/bonding. Notably, the shape of these features can support the flow of hot air between layers to pre-heat or begin the melt activity necessary for adhesion. In any case, the approach simplifies the process of laminating thermoplastic composite tapes and pre-forms. The hot melting adhesive is utilized in two steps. First to simplify layer placement especially in inverted or difficult geometric mold situations, and secondly it melts to become the bond line adhesive component. As such, no tape, pins or other securing means are necessary in the composite processing.

Any of the backing-applied features may be of such type that melt and bond and lose their discrete identity/form upon heating. Use of such features may help to stabilize parts for bonding. They may also increase bond strength, especially when at least some of the members incorporated high-tenacity/melt fiber or are otherwise reinforced.

In yet another approach, elevated features are provided upon at least one of two members to bond. However, instead of seeking to fill complementary space as in either approach above, the gaps are filled with a structural foam or another material with higher melt temperature than the bonding matrix (e.g., higher molecular weight PET—such as used in comingled srPET fabric—in the form of beads, pucks, pellets, straws, single honeycomb cells or another configuration or LWRT as described by the applicant hereof as called out and incorporated by reference below). When foam is used, the remainder of the foam planed off. The resulting structure then includes locally cored regions. The diameter (length and/or width) of these coring structures can easily be set at the mm or sub-millimeter scale. When welding a body so-prepared to another, the high melt temp filler maintains a desirable gap or distance between the parts. It can also prevent unwanted outflow of matrix material when compressing the parts together. Moreover, when complementarily cored pieces are employed, a unique moderate-density structure is produced with coring and matrix bridging elements. Such an implementation can be visualized in connection with FIG. 5 with the addition of ancillary foam 54 optionally filling the gaps between beads 52, 52′ (but only illustrated in the left-most section of the figure).

In another implementation, raised features form channels or micro-channels for flowing a welding solvent between opposed material. Again, FIG. 5 illustrates and appropriate configuration for such purpose. A solvent (not shown) then introduced as injected, by gravity feed, under pressure, etc. can effect welding between the pieces in an evenly distributed pattern or flow path.

Note that any of the above bump/raised features may be formed by heating thermoplastic composite fabric so its matrix material flows in communication with a textured backing (e.g., molded silicone) or by employing a heated stamper or roller. Another approach is to machine (mechanically, by laser, water-jet or otherwise) the features in a bonded composite layer or a contact (film) layer to bond to a composite panel layer. Other printing or deposition approaches may be employed as well, including hot-melt, silk screening and other approaches. Any of these enable precise metering of the matrix material intended for bonding, processing high volume at low cost. Using this inexpensive high volume processes permits precise metering of thermoplastic adhesives to be accurately metered onto a surface in a precise shape. The dots, squares, or specified shapes need only to be melted with pressure and time enough to allow the shapes to engage each other. Most all thermoplastic adhesives have very high melt viscosity requiring high pressures and long dwell times to squeeze excess adhesive out the edges of a laminate. The patterns can also be designed to channel out air during the weld similar to the action of tire treads.

### Multi-Modal Composite Preforms for Welded Constructs

U.S. Pat. Nos. 5,418,035; 5,464,493 and 6,162,314 offer a useful tool. However, their purpose and implementation is limited. The patents merely contemplate tacking multiple layers of composite together for manipulation in bulk. Moreover, none recognize the benefit of (aspects of the '035 and '493 actually teach away from) creating performs with one or more hinging sections connecting adjacent less flexible (i.e., semi-bonded or unbonded phase fabric) composite sections.

In these aspects of the present inventions, selective bonding of a preform for producing a final product is usefully implemented even with a single layer of thermoplastic composite material fabric (vs. stacked material). In certain embodiments, it is most advantageously so-implemented. Regarding discussion of the various phases to which thermoplastic composite material may be consolidated, reference is made to PCT application entitled, “Hybrid Thermoplastic Composite Goods,” filed on even date herewith and incorporated by reference in its entirety.

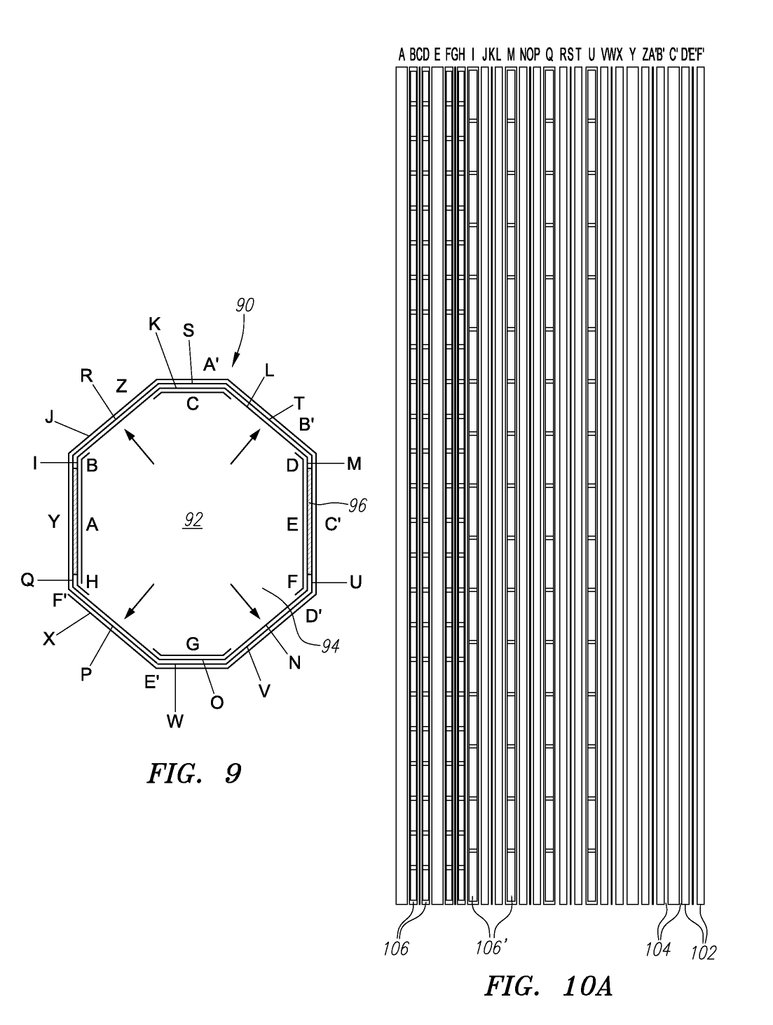

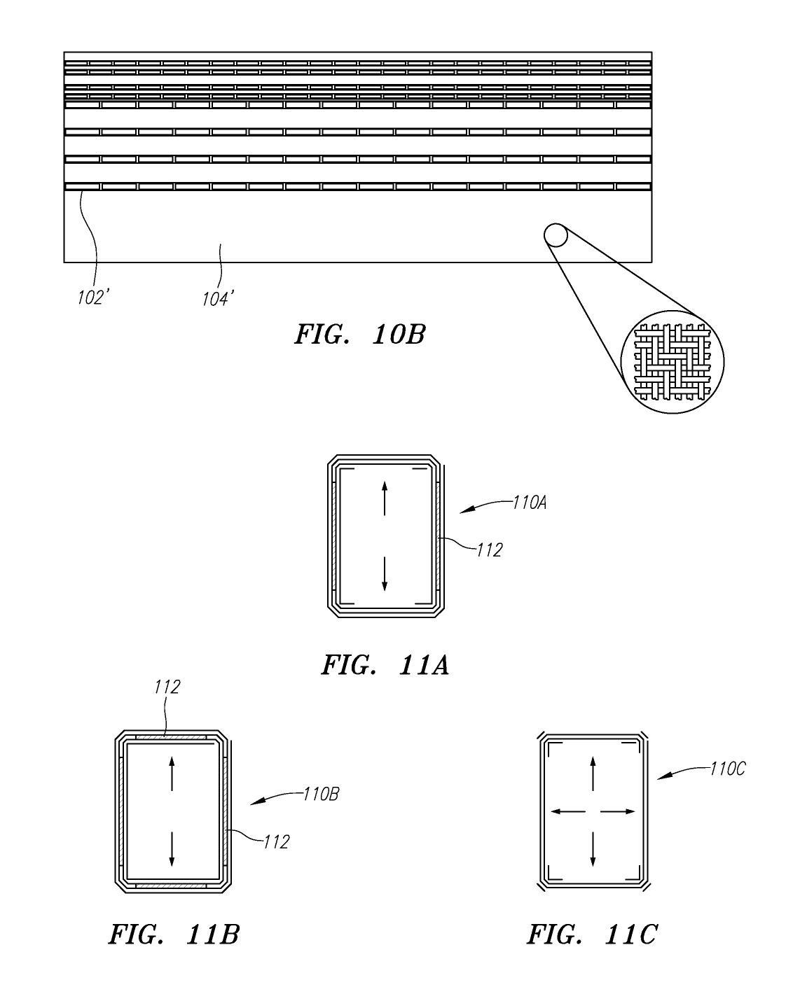

In reference to the lacrosse handle embodiment (a lacrosse handle 90 illustrated in cross section in FIG. 9), a flat sheet of material 100A or 100B as shown prepared in FIG. 10A or 10B, respectively, is provided that includes a plurality of consolidated/bonded sections or semi-consolidated/bonded sections 102 and a plurality of more flexible semi-bonded or un-bonded sections 104. In one aspect of the inventions, such a multi-phase perform is wrapped around a silicone mandrel 92 and set in a mold or vacuum bagged and heated to fully-bond the composite material. A lacrosse handle, a hockey handle (three versions 110A, 110B and 11C illustrated in cross in FIGS. 11A-11C) or another type of faceted hollow body or shaft can advantageously be so-produced.

With the flexible sections defining hinge lines/sections, precision placement can be achieved with more rigid sections (e.g., sections A-H) seating/lying against complementary mandrel/mold sections. The flexible sections, then, operate as hinges for layup (e.g., over a complex surface) or wrapping (e.g., over one or more mandrels).

When involving selectively laminated layers of material, unbonded flexible sections of material can define pockets to receive other material. For example, Nitinol ribs or spars/stringers (not shown) may be slipped in between layers along the hinges and precisely aligned in this fashion. Otherwise, additional composite material tow lines (preferably comingled thermoplastic composite such as used for the fabric layers itself) can be passed between the layers (not shown).

As another option, the more flexible sections can define paths for stitching/sewing the layers together. The stitching can help prevent delaminating in the final composite product against impact damage in the finally-bonded product. Especially when the flexible sections are used as hinge elements in wrapping a preform around a mandrel to define a handle with edges subject to impact (as in a lacrosse or hockey stick), the sewing may be especially useful. High strength filament/thread may be used for the sewing such as SPECTRA, VECTRAN or DYNEMA for such purposes.

Another option is to modify the more rigid/bonded sections. Particularly, they may be cut-out (e.g., using a punch press, CNC mill or drag knife). The resulting cutouts 106 then can play a role in defining a lighter weight and higher performance structure.

In one example, cutouts are placed along the internal surface of the structure. This can lighten the wall of a structure while maintaining full thickness along its edges/corners. This may be advantageous when the primary failure conditions is impact/impulse loading at the corners. The cutouts 106 may also (or alternatively) serve as location features with coordinated protrusions 94 on opposing molding body (i.e., the mandrel, a mold cavity, etc.).

In another example, cutouts 106′ are trapped between overlaying “skin” layers. These may be left vacant or filled with inserts 96 made of foam, honeycomb, LWRT, etc. Such an approach may be especially advantageous from the perspective of reducing overall weight while maintaining optimal beam strength. Of course, hybrid constructions can be provided in which both of these tools are employed.

Open or closed-off, the cutout pattern can be designed to deliver desired properties. Especially when the composite structural fibers are aligned with the struts of a cutout pattern (e.g., at +/−45°, the pattern can advantageously define various truss shapes (e.g., comprising triangles and trapezoids) either to be filled-in with support material or not. Still further, it is to be recognized that cutout sections may be set at the exterior of the piece. Doing so can provide grip, tactile indicators or offer other features.

Also, it is to be understood that while the examples show wrapping or rolling a single segmented preform for defining the final structure (when fully bonded), multiple preform pieces or sections can be so employed. For example, one preform may define medial layer(s) with a given cutout pattern and other preforms define inner or outer skin layers.

In addition, the preform may be configured in different manners to achieve the same result. Specifically, depending on fiber orientation, more or less of the material may be fully or semi-bonded in defining a stable structure for wrapping a mandrel. With 0/90° fiber orientation (an example of such shown in the detail in FIG. 10B) where the fabric is unconsolidated, both of the open performs 100A and 100B can be tightly wound around a mandrel—whereas the preform in FIG. 10A is a combination of fully-bonded and semi-bonded or unbonded “hinge” sections and that in FIG. 10B is a combination of fully bonded or semi-bonded “border” sections 102′ and semi-bonded or unbonded “spanning” sections 104′ paired respectively). However, with fabric fiber weave/braid oriented at +/−45°, any such unbonded material may tend to stretch more when wrapping. Therefore, a fully bonded plus semi-bonded structure may be more desirable in this case to ensure consistent wrapping under such circumstances.

In any case, the different hockey stick handle configurations 110A, 110B and 110C shown in FIGS. 11A-11C can be similarly constructed. These are shown fully bonded/welded after welding/molding and mandrel removal. Each include inserts 112 (as above) and/or pockets 114 as optionally provided. A single handle may include each such cross section or be made using a pattern that is consistent along its axis.

### Variations

It is contemplated that any optional feature of the inventive variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity.

The breadth of the present inventions is not to be limited to the examples provided and/or the subject specification, but rather only by the scope of the claim language. Use of the term “invention” herein is not intended to limit the scope of the claims in any manner. Rather it should be recognized that the “invention” includes the many variations explicitly or implicitly described herein, including those variations that would be obvious to one of ordinary skill in the art upon reading the present specification. Further, it is not intended that any section or subsection of this specification (e.g., the Summary, Detailed Description, Abstract, Field of the Invention, etc.) be accorded special significance in describing the inventions relative to another or the claims. Any of the teachings presented in one section, may be applied to and/or incorporated in another. The same holds true for the teaching of any of the related applications with respect to any section of the present disclosure. The related applications are: Low Weight Reinforced Thermoplastic Composite Goods (US provisional application); Reconfigured Thermoplastic Composite Constructs (US provisional application); Topo-Slice Thermoplastic Composite Components and Products (PCT application); Panel-Derived Thermoplastic Composite Components and Products (PCT application); and Hybrid Thermoplastic Composite Goods (PCT application) each to the assignee hereof and filed on even date, herewith. Moreover, each and every one of these applications is incorporated by reference herein in its entirety for any and all purposes, as are all of the other references cited herein. Should any US published patent application or US patent claim priority to and include the teachings of one or more of the aforementioned US provisional applications, then that US published patent application and that US patent is likewise incorporated by reference herein to the extent it conveys those same teachings. The assignee reserves the right to amend this disclosure to recite those publications or patents by name. Although the foregoing inventions has been described in detail for purposes of clarity of understanding, it is contemplated that certain modifications may be practiced within the scope of the claims to be made.

1. A method of manufacture with thermoplastic material members designed for a welded assembly, the method comprising:
fitting a piece of thermoplastic material with a weld-assisting feature to a complementary-shaped element,
heating the piece to melt the weld-assisting feature for bonding using the thermoplastic material.

2. The method of claim 1, wherein the complementary element is another piece of thermoplastic material with a related weld-assisting feature.

3. The method of claim 2, wherein the related weld-assisting feature of each piece is a curved surface.

4. The method of claim 2, wherein the related weld-assisting feature of each piece are raised features.

5. The method of claim 2, wherein the related raised features can only be interfit in one orientation.

6. The method of claim 2, wherein the related raised features have substantially the same shape.

7. The method of claim 2, wherein the related features comprise a puzzle-piece and receptacle.

8. The method of claim 2, wherein the features comprise a vertical mechanical interlock.

9. The method of claim 2, wherein the features melt and are no longer distinguishable upon heating.

10. The method of claim 1, wherein the interfitting element is a mandrel and the weld-assisting feature are a plurality of foldable sections for fitting to the mandrel and overlaying each other for welding together.
